(19) United States
(12) Patent Application Publication
(10) Pub. No.: US 2012/0103976 A1
(43) Pub. Date: May 3, 2012

(54) APPARATUS FOR HEATING CONTAINERS

(75) Inventor: Stefano Boido, Calamandrana (Asti) (IT)

(73) Assignee: Microwine S.r.l., Torino (IT)

(21) Appl. No.: 13/287,964

(22) Filed: Nov. 2, 2011

(30) Foreign Application Priority Data
Nov. 2, 2010 (EP) 10189662.9

(51) Int. Cl. H05B 6/64; H05B 6/78

(52) U.S. Cl. 219/690

(57) ABSTRACT

An apparatus for heating containers, comprising a carousel structure, which turns about a vertical axis and carries a plurality of microwave heating units, wherein each microwave heating unit comprises a heating chamber designed to receive a respective container and a microwave generator connected to a waveguide, which communicates with the respective heating chamber, wherein each of said heating chambers has a base on which a respective container is to rest, a rear wall, which extends upwards from said base, and a lid, which is mobile between an open position for insertion and removal of the containers and a closed position for microwave heating of the containers, and wherein said waveguide has an output section open on said rear wall, an input station, designed for loading the containers to be heated into respective heating chambers, and an output station, designed for removing the containers heated by said heating chambers.

### CROSS-REFERENCE TO RELATED APPLICATIONS

This application claims benefit of European patent application number 10189662.9, filed Nov. 2, 2010, which is herein incorporated by reference.

### BACKGROUND OF THE INVENTION

1. Field of the Invention

The present invention relates in general to systems for filling and closing containers and regards in particular an apparatus for heating containers.

The present invention has been developed with particular reference to its application to wine-bottling plants. The present invention can, however, be applied in general to systems for filling and closing containers of different shapes and materials, such as for example glass, plastic, etc., that contain liquid or solid products of various types, of a foodstuff or non-foodstuff nature.

2. Description of the Related Art

Wines are normally bottled at low temperature, usually in the region of 1-3° C.

Downstream of the bottling station, on account of the low temperature, on the outer surface of the bottles a layer of condensate is formed. The layer of condensate would render very problematical the application of the labels on the bottles.

In bottling plants with high production capacity an apparatus for heating the bottles is usually provided, set between an apparatus for filling/closing the bottles and a labelling apparatus.

The document No. WO2009/001208 describes a microwave heating apparatus according to the preamble of claim 1, comprising an input station, a carousel structure, which turns about a vertical axis and carries a plurality of microwave heating devices, and an output station. Each of said microwave heating devices comprises an openable heating chamber, designed to receive a respective bottle, and a microwave generator, arranged for conveying a microwave flow into said chamber.

In order for a microwave heating apparatus of this type to be economically advantageous as compared to more traditional heating apparatuses (for example, of the type with hot-water spray), it is necessary for the apparatus to be able to ensure a high efficiency of energy transfer from the microwave flow to the liquid contained in the bottles. In particular, it is necessary to ensure that the efficiency of the heating process is high with any bottle format. In general, an apparatus optimized to obtain a high efficiency with bottles of a certain format will have a much lower efficiency when it operates with bottles of a different format.

Experimental tests have shown that the efficiency of the energy transfer from the microwave flow to the liquid varies considerably as a function of the position of the bottle with respect to the output of the waveguide of the microwave generator.

### SUMMARY OF THE INVENTION

The object of the present invention is to provide an apparatus for microwave heating of bottles that will enable an optimal efficiency to be obtained with bottles of any format.

According to the present invention, the above object is achieved by an apparatus having the characteristics forming the subject of claim 1.

The claims form an integral part of the teaching provided herein in relation to the invention.

### BRIEF DESCRIPTION OF THE DRAWINGS

The characteristics and advantages of the present invention will emerge clearly from the ensuing detailed description, which is provided purely by way of non-limiting example, with reference to the attached drawings, in which:

FIG. 1 is a perspective view of an apparatus according to the present invention;

FIG. 2 is a side view of a heating unit indicated by the arrow II in FIG. 1;

FIG. 3 is a perspective view of a heating chamber indicated by the arrow III in FIG. 2;

FIGS. 4-6 are plan views that illustrate the sequence for loading the bottles into the respective heating chambers; and

FIGS. 7 and 8 are top plan views that illustrate the sequence of unloading of the bottles.

### DETAILED DESCRIPTION

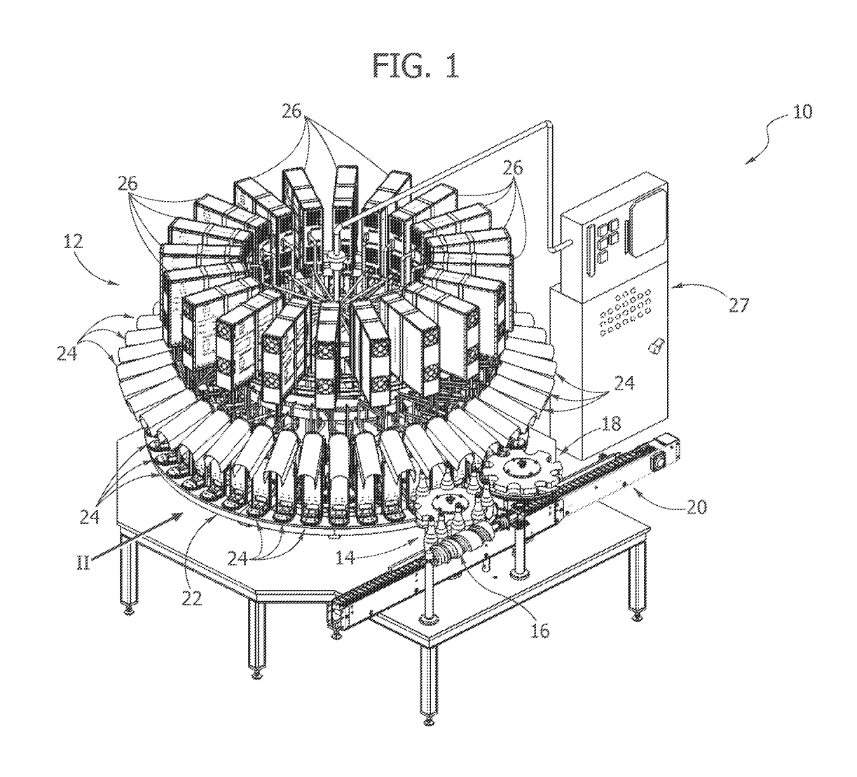

With reference to FIG. 1, designated by 10 is an apparatus for heating bottles according to the present invention. The apparatus 10 comprises a carousel structure 12 that can turn about a vertical axis, an input station 14 associated to an input conveyor 16, and an output station 18 associated to an output conveyor 20.

The carousel structure 12 comprises a rotating supporting base 22, which carries a plurality of heating units 24 arranged according to a radial configuration.

The carousel structure 12 moreover carries a plurality of electric power supplies 26 that are electrically connected to a power-supply and control board 27 by means of a rotary collector. Also the power supplies are arranged according to a radial configuration. Each electric-power supply 26 is associated to one or more heating units 24. In the example illustrated, each power supply 26 is associated to two heating units 24.

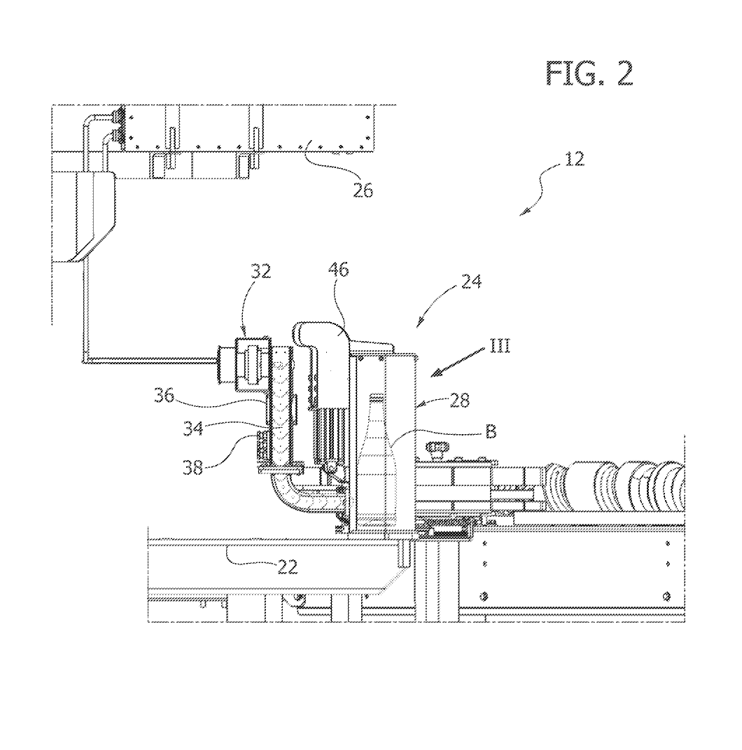

With reference to FIG. 2, each heating unit 24 comprises an openable heating chamber 28, designed to receive a respective bottle B. Each heating unit 24 comprises a respective microwave generator 32, electrically connected to the respective power supply 26. The microwave generator 32 is connected to a waveguide 34 that conveys the microwave flow produced by the generator 32 into the heating chamber 28. On the waveguide 34 there may be provided a circulator 36, which protects the generator 32 from the return waves, and a tuner 38, which enables tuning of the microwave flow on the load to be heated.

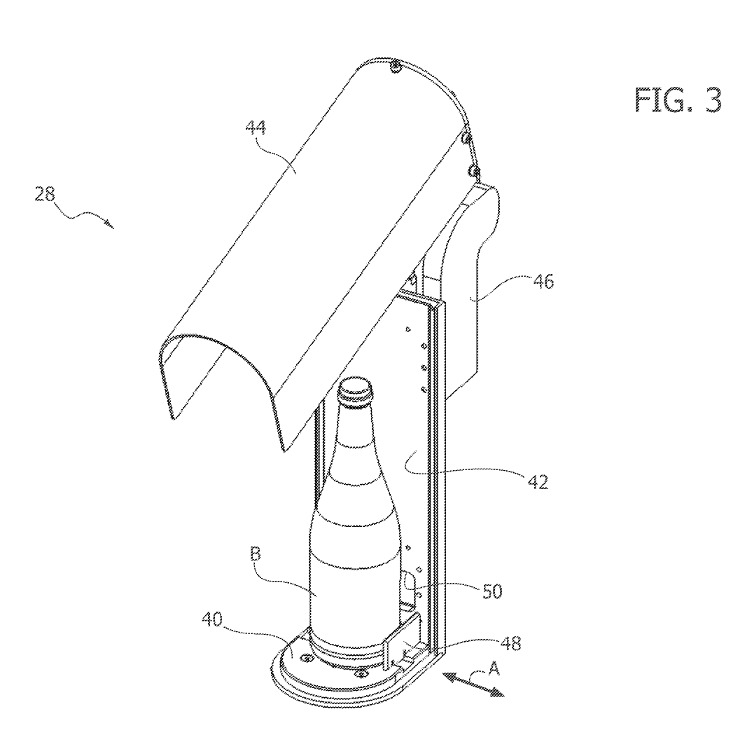

With reference to FIG. 3, each heating chamber 28 comprises a horizontal resting base 40, on which a respective bottle B is to rest, a rear wall 42, which extends in a vertical plane orthogonal to the resting base 40, and an openable lid 44 controlled by an opening and closing mechanism 46. The heating chamber 28 further comprises a positioning wall 48, which serves as reference for defining the right position of the bottle B with respect to the heating chamber 28. The positioning wall 48 extends upwards from the base 40 and preferably in a vertical plane. The positioning wall 48 is preferably adjustable in a horizontal direction A orthogonal to the plane of the wall 48.

The rear wall 42 of the heating chamber 28 has an opening 50, connected to which is an end of the waveguide 34. The opening 50 is set in the proximity of the base 40 in such a way that said opening always faces the wall of the bottles B, also in the case of bottles of small format. Preferably, the distance between the lower edge of the opening 50 and the base 40 is comprised between 1 and 3 cm. The height of the opening 50 is preferably comprised between 3 and 6 cm.

The rear wall 42, the lid 44, and the base 40 are made of a material that provides shielding from microwaves, typically metal, for example steel, and in the closed position of the lid 44 form a microwave shield closed around the bottle B.

According to a particularly important characteristic of the present invention, the bottles are set in contact with the rear wall 42 in such a way that the outer wall of the bottle is directly in contact with the opening 50, coming out of which is the microwave flow. This positioning moreover affords a high efficiency irrespective of the bottle format.

Experimental tests have shown that, with the bottles positioned in this way, an optimal efficiency of the transformation into heat of the energy of the microwave flow is thus obtained. The tests have shown that if the bottles were set at a distance even only a few millimetres from the edge of the opening 50 the efficiency would decay drastically.

A lower efficiency would demand the use of more powerful microwave generators and power supplies, which implies higher costs, larger dimensions of the rotary structure, and higher levels of consumption of electrical energy.

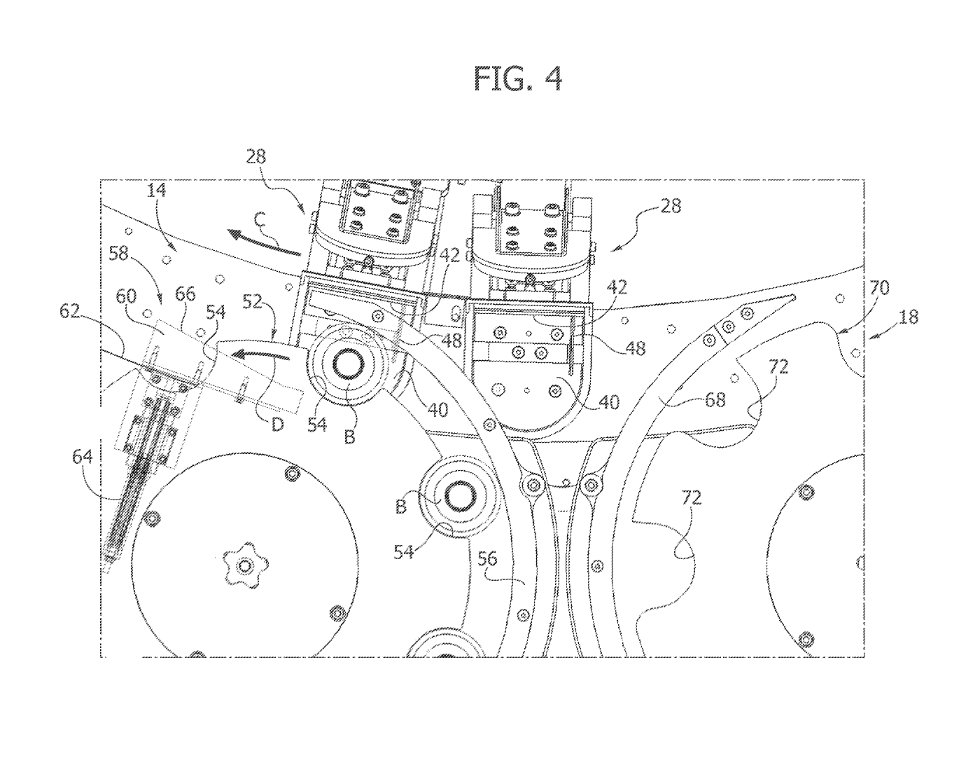

FIGS. 4 to 12 illustrate the constructional arrangement and the operating sequence of the system that enables loading of the bottles B in the respective heating chambers 28 in such a way that the bottles are always in contact with the rear wall 42 of the heating chamber 28.

With reference to FIG. 4, the input station 14 comprises a transfer wheel 52 provided on its periphery with seats with semicircular profile, which are designed to receive respective bottles B. The transfer wheel 52 and the rotary structure 12 are able to rotate about respective vertical axes in the directions indicated by the arrows C and D and are controlled in rotation in phase with respect to one another. The transfer wheel picks up successive bottles B from the input conveyor according to a technique in itself known in the sector of bottling plants.

The transfer wheel 54 faces a stationary guide 56, which functions as containment along the transfer path of the bottles B from the input conveyor 16 to the respective heating chambers 28.

The input station 14 comprises a pusher device 58, designed to push the bottles into contact with the rear wall 24 of the respective heating chamber 28. The pusher device comprises a cam element 60 carried by a stationary structure 62. The cam element 60 is associated to an elastic device 64, which enables the cam element 60 to perform minor displacements in a horizontal plane with respect to the stationary structure 62. The cam element 60 has an inclined surface 66, designed to push the bottles B radially outwards, with reference to the axis of rotation of the transfer wheel 52.

The cam element 60 is set at the end of the guide 56, in the area in which the bottles B are translated from the respective seats 54 of the transfer wheel 52 to the respective heating chambers 28.

FIGS. 4-6 illustrate the sequence according to which a bottle B is loaded in a respective heating chamber 28. The rotary structure 12 and the transfer wheel 52 turn in phase in the directions indicated by the arrows C and D. In the proximity of the loading station 14, the lids 44 of the heating chambers 28 are lifted.

During the transfer step, the bottle B is in contact simultaneously with the positioning wall 48 of the respective heating chamber 28 and with the inclined surface 66 of the cam element 60.

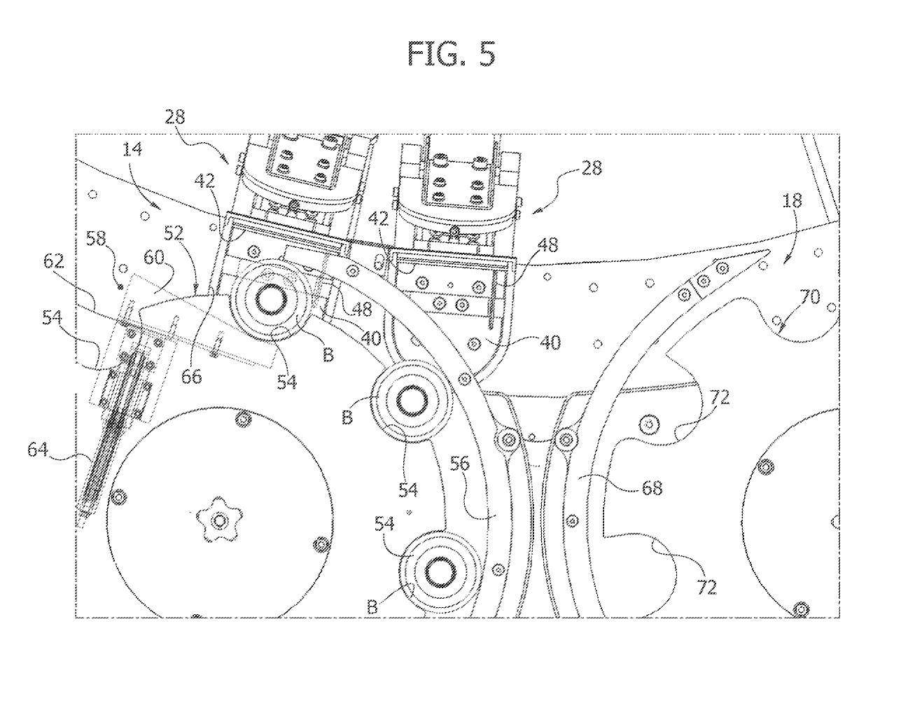

As illustrated in FIG. 5, the cam element 60 pushes the bottle B towards the heating chamber 28, and the positioning wall 48 guides the bottle B in such a way that the latter assumes the desired position with respect to the heating chamber 28.

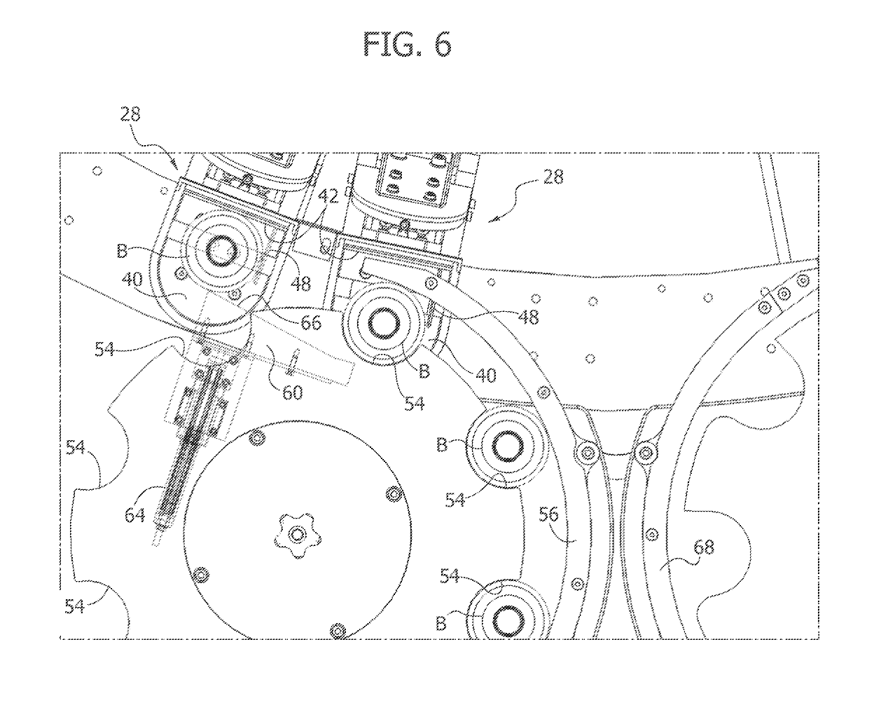

As illustrated in FIG. 6, the thrust on the bottle B by the cam element 66 proceeds until the bottle B comes into contact with the rear wall 42 of the respective heating chamber 28. The elastic device 64 enables a slight movement of the cam element 60 when the bottle has come into contact with the rear surface 42.

This system guarantees that the bottles B are positioned in the respective heating chambers 28 in contact with the rear wall 42, with the wall of the bottle B in direct contact with the opening 50, coming out of which is the microwave flow. This positioning of the bottles ensures the maximum efficiency of the transformation into heat of the energy of the microwave flow.

Once loading of a bottle B into the respective heating chamber 28 is completed, the lid 44 is closed and the respective microwave generator is activated.

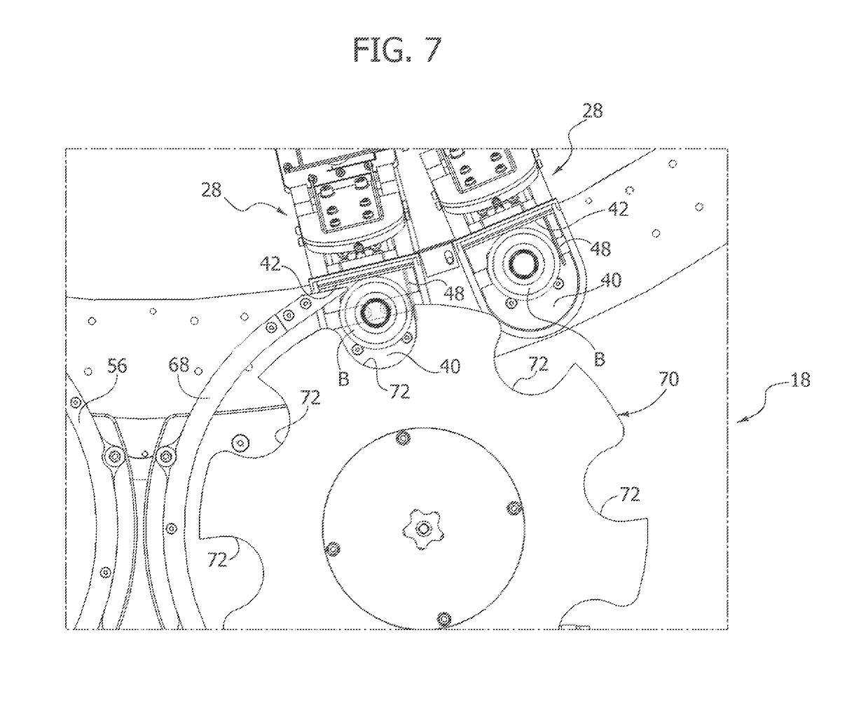

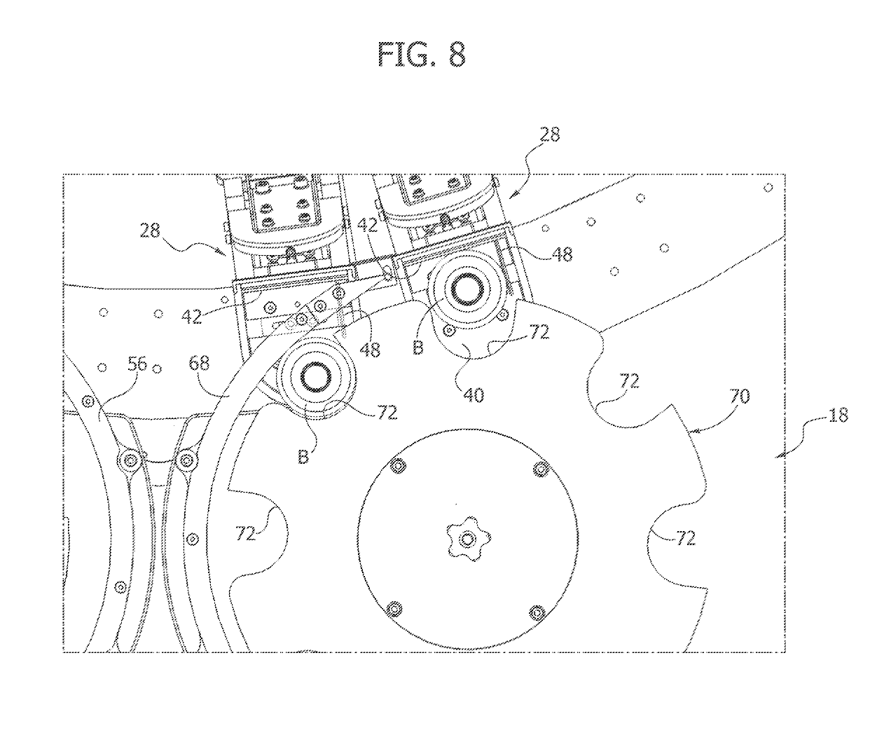

The cycle for heating a bottle B terminates when the respective heating chamber 28 arrives at the unloading station 18. The lid 44 is opened, and the bottle B is unloaded, as illustrated in FIGS. 7 and 8.

During the unloading step, the containment wall 48 pushes the bottle B against a stationary guide 68 facing a transfer wheel 70 similar to the transfer wheel 52 of the loading station 14. The transfer wheel 70 turns about a vertical axis in phase with the rotary structure 12 and is provided with a plurality of semicircular seats 72. The combined action of the containment wall 48 and of the guide 68 pushes the bottle B into a respective seat 72 of the transfer wheel 70.

While the foregoing is directed to embodiments of the present invention, other and further embodiments of the invention may be devised without departing from the basic scope thereof, and the scope thereof is determined by the claims that follow.

1. An apparatus for heating containers, comprising:
a carousel structure, which turns about a vertical axis and carries a plurality of microwave heating units, wherein each of said microwave heating units comprises a heating chamber designed to receive a respective container and a microwave generator connected to a waveguide, which communicates with the respective heating chamber, wherein each of said heating chambers has a base, on which a respective container is to rest, a rear wall, which extends upwards from said base, and a lid, which is mobile between an open position for insertion and removal of the containers and a closed position for microwave heating of the containers, and wherein said waveguide has an output section open on said rear wall,
an input station, designed for loading the containers to be heated into respective heating chambers; and
an output station, designed for removing the containers heated by said heating chambers,
said input station comprises a pusher device designed to position said containers in contact with said rear wall of the respective heating chamber.

2. The apparatus according to claim 1, wherein said pusher device comprises a cam element carried by a stationary structure and associated to an elastic device designed to enable a movement of said cam element in a horizontal plane.

3. The apparatus according to claim 1, wherein said input station comprises a transfer wheel that can turn about a vertical axis in phase with said rotary structure.

4. The apparatus according to claim 1, wherein each of said heating chambers comprises a containment wall extending in a vertical plane orthogonal to said base and to said vertical wall.

5. The apparatus according to claim 4, wherein said containment wall is adjustable in a direction orthogonal to said vertical plane.
